(19) United States
(12) Patent Application Publication
(10) Pub. No.: US 2001/0038473 A1
(43) Pub. Date: Nov. 8, 2001

(54) Devices and methods for controlling protection switching in an optical channel shared protection ring

(76) Inventors: Ming-Jun Li, Horseheads, NY (US); Mark J. Soulliere, Corning, NY (US)

Correspondence Address: CORNING INCORPORATED, SP-TI-3-1, CORNING, NY, 14831

(21) Appl. No.: 09/802,624

(22) Filed: Mar. 9, 2001

Related U.S. Application Data
(60) Provisional application No. 60/188,397, filed on Mar. 10, 2000.

(51) Int. Cl. H04B 10/08; H04B 10/20; H04J 14/00

(52) U.S. Cl. 359/110; 359/119

(57) ABSTRACT

An optical channel shared protection ring including multiple ring nodes, the nodes including optical switch or crossbar capability for performing ring switching for end-node protection switching for wavelengths that may be dropped and added and a non-intrusive optical channel monitor at least on each working channel both on the add and drop side of the node, such that a monitor is always present at both a head-end location where traffic is introduced to the ring and at a tail end location where traffic leaves the ring, so as to be able to trigger end-node protection switching performed by the head-end and tail-end nodes based on the condition of absence of adequate signal at the tail-end location alone, and not on the condition of absence of adequate signal at both the head-end and the tail-end location, thus avoiding unnecessary protection switching.

This application hereby claims the benefit of priority to U.S. Provisional Patent Application No. 60/188,397 filed Mar. 10, 2000.

### BACKGROUND OF THE INVENTION

1. Field of the Invention

The present invention relates generally to optical protection switching in an optical channel shared-protection ring, and particularly to devices and methods for implementing optical protection switching in an optical channel shared-protection ring.

2. Technical Background

As demand for communications bandwidth reaches ever higher levels, there is increased need for flexible and reliable ways to provision optical channels. In an optical network, some levels of redundancy can be used to provide “protection” against failures such as fiber or cable cuts, thereby increasing reliability and flexibility of the network.

FIG. 1 shows a diagram of a two-fiber optical channel shared protection ring under normal (failure-free) conditions. The ring includes two fibers 30, 40 and four ring nodes 102, 104, 106, and 108. Each ring node 102, 104, 106, and 108 includes at least some add-drop switching capability so as to allow selective connection to wavelengths on the ring. For simplicity, only two wavelengths are represented in the configuration shown, which wavelengths are switched at nodes 102 and 108 so as to link clients at nodes 102 and 108. Primary traffic is carried between primary clients P1 and P2 via ring nodes 102 and 108. The clients may be other network nodes, or any other communications port or terminal employing an optical channel for signaling. The wavelength used in going from P1 to P2, λ(k), is different from λ(j), the wavelength used in going back from P2 to P1. These wavelengths travel on working capacity (i.e., working wavelengths) on the 2-fiber optical channel shared protection ring. The working capacity or wavelengths are reused to carry primary traffic between primary clients P3 and P4 via nodes 102, 104, 106, and 108. The corresponding protection capacity is used to carry extra (pre-emptable) traffic between extra client nodes E1 and E2, as well as between extra client nodes E3 and E4, as shown. Of course, many more wavelengths than the two wavelengths shown may be utilized simultaneously on a given ring, as “working” or “protection” wavelengths, for connecting other combinations of pairs of nodes on the ring.

FIG. 2 illustrates operation of the ring when a cable cut occurs. The example of FIG. 2 is for a cable (fiber) cut between nodes 102 and 108, but the same procedure and principles apply to a cable cut between any two of the nodes 102-108. The cable cut between nodes 102 and 108 disrupts the primary traffic between primary clients P3 and P4. The ring responds by disconnecting the extra traffic on the ring, and using the protection capacity between nodes A and D to restore the traffic from P3 to P4. Signaling is used among the ring nodes to accomplish these actions. Switching of this type is known as “end-node” switching because the end nodes, i.e., the nodes at the ends of the interrupted primary traffic path, perform the switching. The switching performed at the end nodes, which involves switching or bridging the disrupted primary clients to the protection channels on the unbroken portion of the ring, is known as a “ring switch”. End-node switching may also be utilized in four-fiber or other ring configurations, in addition to the two-fiber ring shown as an example in FIGS. 1 and 2. In order to perform this protection switching at appropriate times, a means and method must be provided to detect when protection switching should occur.

### SUMMARY OF THE INVENTION

In one aspect of the present invention, an optical shared protection ring is provided including multiple ring nodes. Two fibers or four (or more) may be employed for the ring. The nodes include optical switch or crossbar capability for performing ring switching for end-node protection switching for wavelengths that are or may be dropped and added at that node. The nodes include a non-intrusive optical channel monitor at least on each working channel both on the add and drop side of the node, such that a monitor is present at both a head-end location where traffic is introduced to the ring and at a tail end location where traffic leaves the ring, so as to be able to trigger end-node protection switching performed by the head-end and tail-end nodes based on the condition of absence of adequate signal at the tail-end location only, and not on the condition of absence of adequate signal at both the head-end and the tail-end location.

Another aspect of the invention involves a method of triggering and performing end-node protection switching in an optical shared protection ring by first detecting absence of adequate signal at a node at a tail-end location where a channel leaves the ring, then signaling the node at a head-end location where said channel enters the ring that a protection switch operation may be necessary, then detecting the presence or absence of adequate signal in said channel at the head-end location, then performing a protection switching at the head-end node and signaling the tail-end node to perform a protection switch only if adequate signal is present in the channel at the head-end location, then performing a protection switching at the tail-end node if signaled by the head-end node.

Yet another aspect of the invention includes a node device for use in an optical channel shared protection ring, the device including add and drop capacity for one or more pairs of working and protection optical channels and a switch or crossbar for performing a ring switch for the protection of said one or more pairs of channels, device including non-intrusive monitors on at least the working channels on both the add and drop sides of the node.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a diagram of a two-fiber shared protection ring under normal operating conditions;

FIG. 2 is a diagram of the ring of FIG. 1 under conditions of a cable or fiber cut;

FIG. 3 is a diagram of one direction of the working and protection channels of FIG. 2 for an example of traffic from node 102 to node 108 showing head and tail non-intrusive monitors in nodes 102 and 108;

FIG. 4 is a diagram showing operation of the nodes 102 and 108 under conditions of a cable cut or other failure in the working channel;

FIG. 5 is a diagram showing operation of the nodes 102 and 108 under conditions of a cable cut or other failure at primary client P3;

FIG. 6 is a diagram of an embodiment of a non-intrusive monitor; and

FIG. 7 is a graph representing an example of the operating conditions of a non-intrusive monitor.

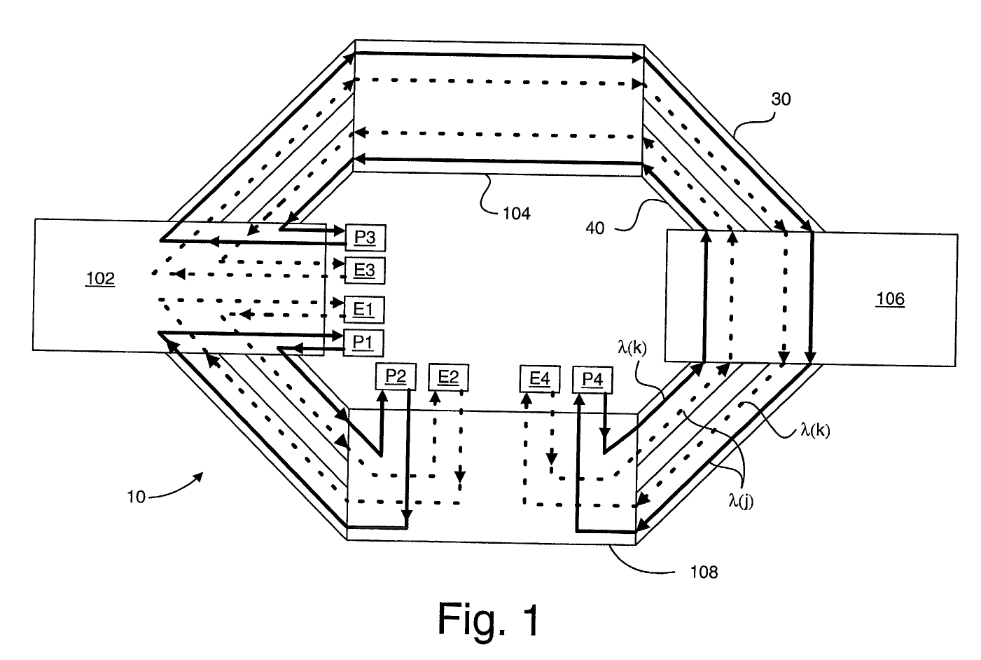

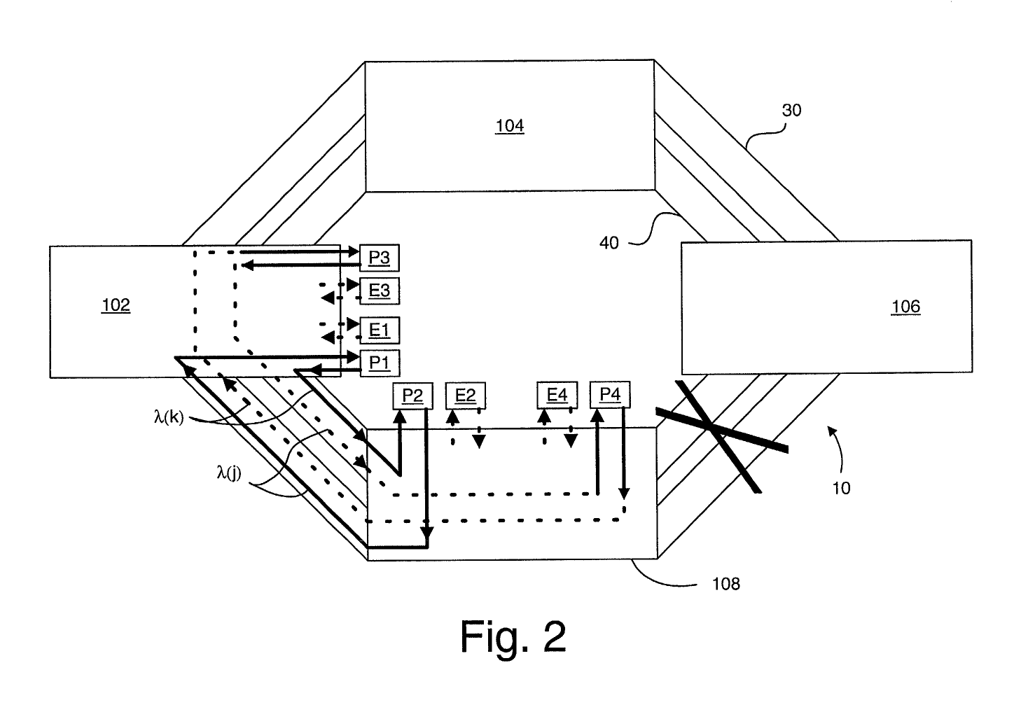

### DETAILED DESCRIPTION OF THE INVENTION

Reference will now be made in detail to the present preferred embodiment of the invention, an example of which is illustrated in the accompanying drawings. Wherever possible, the same reference numbers will be used throughout the drawings to refer to the same or like parts. An exemplary embodiment of an optical protection ring showing key features of the present invention is shown in FIG. 3, and is designated generally throughout by reference numeral 20.

The optical protection ring 20 of FIG. 3 is shown with a primary client P3 connected to the node 102 and further connected, via the ring 20, to primary client P4 via the node 106 of ring 20. For simplicity, only one direction of the connection between P3 and P4 is shown. This connection includes both a working channel W, and a protection channel P that may be used to connect extra client E3 with extra client E4.

Each of nodes 102 and 106 include non-intrusive channel monitors on the working channel W, monitor 22 in node 102 and monitor 62 in node 106. The nodes may also include monitors 24 and 64 on the protection channel. This is desirable for symmetry and flexibility of the node, but is not required in applications or embodiments where symmetry between working and protection channels is not a required.

For the communication direction shown, node 102 is the first ring node to receive the signal (from P3), and is thus termed the “head-end” node, while node 106 is the node that transmits the signal from P3 out of the ring (to P4), and is thus termed the “tail-end” node. The nodes 102 and 106 include add-drop capability at least for the wavelength employed for the two channels (W and P) shown. The nodes 102 and 106 also each include an optical switch or crossbar for performing ring switching.

As an example of the method of the present invention, if the node 106, via monitor 62, an absence of adequate signal on the working channel W at the tail-end location, then node 106 signals the node 102 at the head-end location that a protection switch operation may be needed. This signal may take the form of a switch request from node 106 to node 102. Upon receiving the request or signal, node 102 does not immediately perform the switch, but instead detects the presence or absence of adequate signal at the head-end location by use of monitor 22.

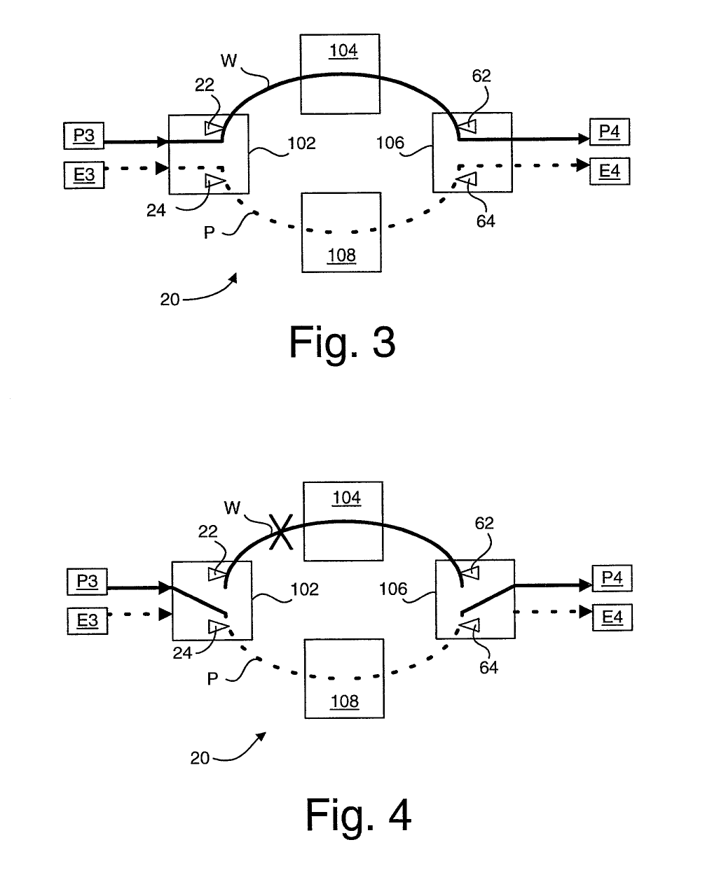

If adequate signal is present at the head end location of the working channel W, then there is likely a fiber or cable cut or other flaw in the working channel W, as illustrated in FIG. 4, and node 102 performs the switch. Traffic from P3 is thus routed onto the protection channel P as shown. The head-end node 102 then signals the tail-end node 106 to perform a corresponding protection switch. The signal may take the form of a switch request from node 102 to node 106. Node 106, as the tail end node, then performs the requested switch, resulting in the coupling of the protection channel P to the primary client P4 as shown.

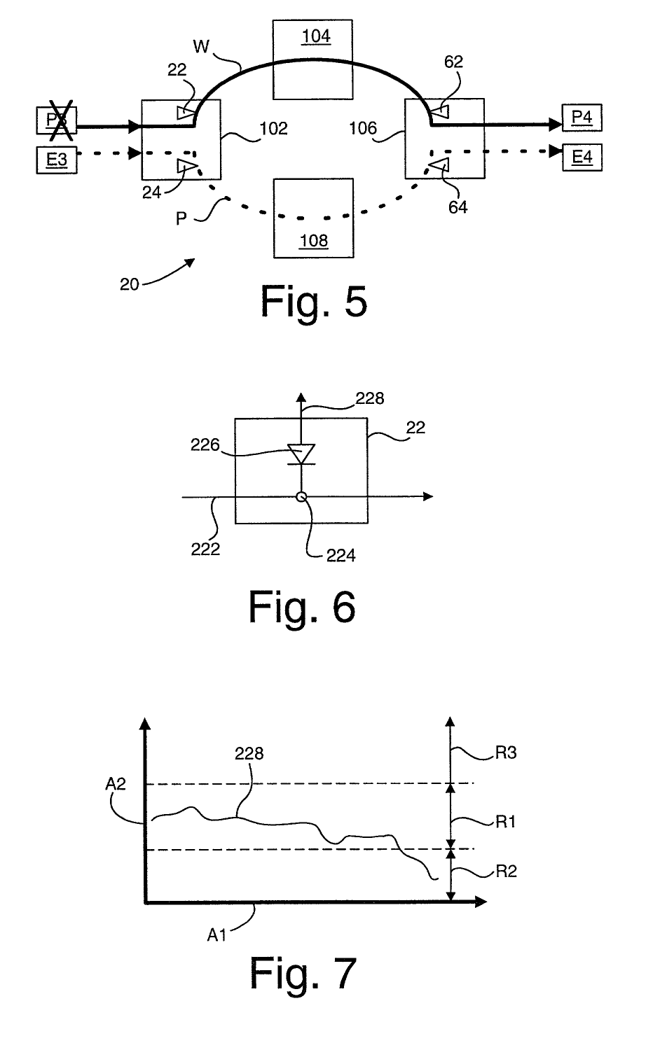

If, on the other hand, adequate signal is not present the head end location of the working channel W, then node 102 does not perform the switch requested by node 106. Absence of adequate signal at the head end location indicates a failure upstream of the ring 20, such as a failure at primary client P3, for example, as illustrated in FIG. 5. Protection switching in this circumstance is unnecessary and is avoided by the presence of the monitor 22 at the head-end location and by the used of the monitor 22 by the head-end node 102 to detect the presence or absence of adequate signal before performing a requested switch. The ring thus remains in the state shown in FIG. 5, with the protection channel P still useful for extra traffic, and the working channel W available for primary traffic whenever it resumes.

The non-intrusive monitors are desirably positioned on the ring (the internal) side of the crossbar or switching capability within the nodes, as shown in FIGS. 3 and 4, so that individual monitors are directly associated with the ring channels. As an alternative, however the monitors at both the head-end and the tail-end locations may of located anywhere within the respective nodes.

FIG. 6 shows an example of the form of the non-intrusive monitor 22. A tap coupler or other suitable tapping device removes a small portion of the light in the fiber or channel 222 to be monitored, and passes the light to a photodiode 226. The photodiode produces an electrical signal 228 corresponding to the intensity of the light. The electrical signal 228 is used by the associated node 102 to detect presence or absence of an acceptable signal in fiber or channel 222.

FIG. 7 shows a graph illustrating an example usage of the monitor of FIG. 6. FIG. 7 shows an example of the magnitude of the electrical signal 228 on the axis A2 as a function of time on the axis A1. Pre-defined ranges R1, R2, and R3 are used as follows. R1 corresponds to the expected magnitude of the electrical signal 228 in the presence of an adequate optical signal in the fiber or channel 222. Thus as long as the signal 228 remains within the range R1, adequate optical signal is detected by the monitor. Whenever the signal 228 drifts out of range R1 into range R2 or range R3 as at then end of the time shown, then an absence of adequate optical signal is detected. Ranges R1 R2 and R3 may be identical for head-end and tail-end detection, or may be different for head-end and tail-end detection to reflect higher signal quality requirements at the head-end than at the tail-end.

Other forms of non-intrusive monitors and monitoring may also be employed. For example, a non-intrusive monitor maybe used that detects the format rather than just the intensity of the signal it monitors, so as to determine the bit error rate (“BER”) of the signal. The acceptable range may then be set in terms of acceptable BER.

Because the ring and nodes of the present invention are arranged such that one monitor is at a head-end location where traffic is introduced to the ring and the other monitor is at a tail-end location where traffic leaves the ring, the ring is able to trigger end-node protection switching performed by the said two nodes based on the condition of absence of adequate signal at the tail-end location only, and not on the condition of absence of adequate signal at both the head-end and the tail-end location. Thus accurate triggering of protection switching may be achieved in a simple and straightforward manner, without special signaling to continually test the various links.

It will be apparent to those skilled in the art that various modifications and variations can be made to the present invention without departing from the spirit and scope of the invention. Thus, it is intended that the present invention cover the modifications and variations of this invention within the scope of the appended claims.

What is claimed is:

1. An optical shared protection ring comprising multiple ring nodes, at least two of said nodes including add and drop capabilities for at least one wavelength and an optical switch or crossbar for performing ring switching, on said wavelength, with one direction of said wavelength around the ring designated as a working channel and another direction designate as a protection channel, said at least two nodes each including a non-intrusive optical channel monitor on the working channel, the ring and nodes arranged such that one said monitor is at a head-end location where traffic is introduced to the ring and the other said monitor is at a tail-end location where traffic leaves the ring so as to be able to trigger protection switching performed by the said two nodes based on the condition of absence of adequate signal at the tail-end location only, and not on the condition of absence of adequate signal at both the head-end and the tail-end location.

2. The ring of claim 1 wherein said monitor is positioned on the ring side of the associated node's switch or crossbar.

3. The ring of claim 1 wherein each of said at least two nodes further include non-intrusive monitors on the protection channel.

4. The ring of claim 1 wherein the ring includes multiple working and protection channels and wherein each node of the ring includes non-intrusive monitors on at least any working channels which that node is capable of adding or dropping.

5. The ring of claim 4 wherein each node of the ring includes non-intrusive monitors on any protection which that node is capable of adding or dropping.

6. The ring of claim 1 wherein the non-intrusive monitor is a signal intensity monitor.

7. The ring of claim 1 wherein the non-intrusive monitor is a bit error rate monitor.

8. A method of triggering and performing end-node protection switching in an optical shared protection ring, the method comprising the steps of: detecting absence of adequate optical signal at a node at a tail-end location where a channel leaves the ring; signaling a node at a head-end location where said channel enters the ring to detect the presence or absence of adequate optical signal in said channel; detecting the presence or absence of adequate optical signal in said channel at the head-end location; performing a protection switching at the head-end node and signaling the tail-end node to perform a protection switch, but only if adequate optical signal is present in said channel at the head-end location; performing a protection switching at the tail-end node if signaled.

9. The method of claim 8 wherein the step of detecting the presence or absence of adequate optical signal in said channel comprises detecting the intensity of the signal in said channel.

10. The method of claim 8 wherein the step of detecting the presence or absence of adequate optical signal in said channel comprises detecting the bit error rate of the signal in said channel.

11. A node device for use in an optical channel shared protection ring, the device including add and drop capacity for one or more pairs of working and protection optical channels and a switch or crossbar for performing a ring switch for the protection of said one or more pairs of channels, said device including non-intrusive monitors on at least the working channels.

12. The device of claim 11 further including non-intrusive monitors on the protection channels.

13. The device of claim 11 wherein the non-intrusive monitors are intensity monitors.

14. The device of claim 11 wherein the non-intrusive monitors are bit error rate monitors.
